(19) United States
(12) Patent Application Publication
(10) Pub. No.: US 2015/0181898 A1
(43) Pub. Date: Jul. 2, 2015

(54) FROZEN HEATED GYOZA AND MANUFACTURING METHOD THEREOF

(71) Applicant: AJINOMOTO CO., INC., Chuo-ku (JP)

(72) Inventors: Kimihiro Tamaki, Oura-gun (JP); Masahiko Murayama, Oura-gun (JP); Takahiro Ito, Oura-gun (JP); Keisuke Imaizumi, Oura-gun (JP)

(73) Assignee: AJINOMOTO CO., INC., Chuo-ku (JP)

(21) Appl. No.: 14/586,271

(22) Filed: Dec. 30, 2014

Related U.S. Application Data
(63) Continuation of application No. PCT/JP2013/068570, filed on Jul. 1, 2013.

(30) Foreign Application Priority Data
Jul. 2, 2012 (JP) 2012-148675

(51) Int. Cl. A21D 15/02; A21D 13/00

(52) U.S. Cl. CPC A21D 15/02; A21D 13/0022

(57) ABSTRACT

A frozen heated gyoza dumpling easy to cook by heating after freeze preservation and superior in the texture can be obtained by attaching a batter liquid containing 70-90 wt % of water to at least a surface to be baked of the gyoza dumpling at a proportion of 18-30 parts by weight per 100 parts by weight of the gyoza dumpling. In addition, a manufacturing method thereof is provided.

### CROSS REFERENCES TO RELATED APPLICATIONS

The present application is a continuation of

International Application No. PCT/JP2013/068570, filed Jul. 1, 2013, which is based upon and claims the benefits of priority to Japanese Application No. 2012-148675, filed Jul. 2, 2012. The entire contents of these applications are incorporated herein by reference.

### BACKGROUND OF THE INVENTION

1. Field of the Invention

The present invention relates to a frozen heated gyoza dumpling and a manufacturing method thereof. More particularly, it relates to a frozen heated gyoza dumpling to be eaten after freezing preservation by heating a surface to be baked in a frying pan and the like, and a manufacturing method thereof.

2. Discussion of the Background

Frozen gyoza dumpling is generally manufactured by wrapping the ingredient (filling), which is a mixture of chopped vegetables, ground meat and the like, with coating dough for gyoza dumpling, heat treating same by steaming and the like, and subjecting same to a freezing treatment. When the frozen gyoza dumplings are served, a basic method includes placing frozen gyoza dumplings side by side in a frying pan with oil spread therein and the like; adding a given amount of water, putting a lid thereon, and applying predetermined thawing and a heat treatment in a steam-baked state to give baked gyoza dumplings. In this method, however, since water is added to a heated frying pan containing oil, oil splashing occurs and water is scattered, which may be dangerous, and further, how it is cooked up varies depending on the amount of water added, and making a clean color of baking requires a skill.

To overcome such defects, various propositions have conventional been made and, for example, a frozen gyoza dumpling is known which is obtained by forming a first layer composed of a batter liquid and a second layer composed of water or a seasoning liquid, contacting the gyoza dumpling with them and subjecting the gyoza dumpling to a freezing treatment, thereby obviating the need for oil and water when heating the gyoza dumpling in a frying pan, and the need for a lid (see, for example, JP-A-2006-296428).

Moreover, it has also been proposed to improve juicy feeling, flavor and texture in eating by mixing gelatin particles swollen on absorption of a seasoning liquid with the food dough (see, for example, JP-A-8-168349). Furthermore, it has also been proposed to improve the strength of the coating dough, without impairing the juicy feeling and umami, by leaving a non-heat-denatured part free of heat denaturation in the filling, in a heat treatment step (see, for example, JP-A-2010-148395).

### SUMMARY OF THE INVENTION

According to one aspect of the invention, a frozen heated gyoza dumpling includes a gyoza dumpling having a surface to be baked, and a frozen batter liquid attached to at least the surface. The frozen batter liquid is made from a batter liquid including 70-90 wt % of water. The batter liquid is applied in an amount of 18-30 parts by weight per 100 parts by weight of the gyoza dumpling.

According to another aspect of the invention, a method of manufacturing a frozen heated gyoza dumpling includes heat treating a raw gyoza dumpling with a surface to be baked formed on one surface of a coating dough which wraps filling, and freezing a heat-treated gyoza dumpling while being in contact with or immersed in 18-30 parts by weight of a batter liquid containing 70-90 wt % of water per 100 parts by weight of the gyoza dumpling, such that the batter liquid is applied only to the surface to be baked, or applied to the surface to be baked and a side surface continuing from the surface to be baked, and that a frozen batter liquid is formed in a height of not more than 8 mm from the surface to be baked.

It is one object of the present invention to provide a frozen heated gyoza dumpling easy for heating cooking after freezing preservation, free of unevenness in baking, and capable of maintaining a crispy texture of the baked surface after heating cooking, and hetero texture and juicy texture of the filling.

It is another object of the present invention to provide a method of manufacturing a frozen heated gyoza dumpling.

In the case of baked gyoza dumpling, since the crispy texture of the baked surface, and hetero texture and juicy texture of the filling are considered to be important as factors determining the quality, the gyoza dumpling described in JP-A-2006-296428 mainly aims to facilitate heating cooking, and is not sufficient in terms of the improvement of the texture of the filling and suppression of the development of unevenness in baking and the like, even though it has achieved a certain level of preferable texture of the coating dough. Also, the food described in JP-A-8-168349 sometimes developed a rough feeling of the filling after heating cooking, and a degraded juicy feeling after lapse of time. Moreover, the food described in JP-A-2010-148395 could not be preserved for a long term even in a frozen state, since there was a possibility of denaturation of the non-heat-denatured part.

The present inventors have found that the above-mentioned problem can be achieved by freeze-attaching a batter liquid containing 70-90 wt % of water to at least a surface to be baked of a gyoza dumpling at a proportion of 18-30 parts by weight per 100 parts by weight of the gyoza dumpling, which resulted in the completion of the present invention.

Accordingly, the present invention provides:
[1] A frozen heated gyoza dumpling comprising a batter liquid containing 70-90 wt % of water, which is attached to at least a surface to be baked of the gyoza dumpling at a proportion of 18-30 parts by weight per 100 parts by weight of the gyoza dumpling.
[2] The frozen heated gyoza dumpling of the above-mentioned [1], wherein the batter liquid comprises fat and/or oil.
[3] The frozen heated gyoza dumpling of the above-mentioned [2], wherein a content of the fat and/or oil in the batter liquid is 5-29.5 wt %.
[4] The frozen heated gyoza dumpling of any of the above-mentioned [1] to [3], wherein the batter liquid comprises starch or grain flour, fat and/or oil and water, wherein a blending weight ratio of the starch or grain flour, fat and/or oil and water is 0.5-5:5-29.5:70-90.
[5] The frozen heated gyoza dumpling of any of the above-mentioned [1] to [3], wherein the batter liquid comprises grain flour, fat and/or oil and water, wherein a blending weight ratio of the grain flour, fat and/or oil and water is 0.5-5:5-29.5:70-90.
[6] The frozen heated gyoza dumpling of the above-mentioned [5], wherein the grain flour is rice flour.
[7] The frozen heated gyoza dumpling of any of the above-mentioned [1] to [6], wherein the batter liquid is attached only to the surface to be baked.
[8] The frozen heated gyoza dumpling of any of the above-mentioned [1] to [6], wherein the batter liquid is attached to the surface to be baked and a side surface continuing from the surface to be baked, and the batter liquid attached to the side surface is in a height of not more than 8 mm from the surface to be baked.
[9] The frozen heated gyoza dumpling of the above-mentioned [8], wherein the batter liquid attached to the side surface is in a height of not more than 5 mm from the surface to be baked.
[10] A method of manufacturing a frozen heated gyoza dumpling, comprising heat treating a raw gyoza dumpling with a surface to be baked formed on one surface of coating dough wrapping the filling, and freezing same while being in contact with or immersed in 18-30 parts by weight of a batter liquid containing 70-90 wt % of water per 100 parts by weight of the gyoza dumpling, such that the batter liquid is attached only on the surface to be baked, or the surface to be baked and a side surface continuing from the surface to be baked and frozen in a height of not more than 8 mm from the surface to be baked.
[11] The method of the above-mentioned [10], wherein the batter liquid attached to the side surface is in a height of not more than 5 mm from the surface to be baked.
[12] The method of the above-mentioned [10], wherein the batter liquid is attached only to the surface to be baked and frozen.
[13] The method of the above-mentioned [10] to [12], wherein the batter liquid comprises fat and/or oil.
[14] The method of the above-mentioned [13], wherein a content of the fat and/or oil in the batter liquid is 5-29.5 wt %.
[15] The method of any of the above-mentioned [10] to [14], wherein the batter liquid comprises starch or grain flour, fat and/or oil and water, wherein a blending weight ratio of the starch or grain flour, fat and/or oil and water is 0.5-5:5-29.5:70-90.
[16] The method of any of the above-mentioned [10] to [14], wherein the batter liquid comprises grain flour, fat and/or oil and water, wherein a blending weight ratio of the grain flour, fat and/or oil and water is 0.5-5:5-29.5:70-90.

According to the present invention, since a particular batter liquid is attached to the surface to be baked, addition of water is not necessary during heating cooking, and the heating cooking operation becomes easy. Moreover, since removing and placing a lid during heating cooking is less frequent, oil splashing and water splashing caused by the addition of water to a heated and oiled frying pan do not occur, and a burn caused thereby can be prevented. Furthermore, since dirt produced by oil splashing and water splashing is less, cleaning can be performed with ease. Since a particular batter liquid is attached in advance to the surface to be baked, a skill is not required, and the development of unevenness in baking of each gyoza dumpling can be suppressed when plural gyoza dumplings are baked simultaneously and excessive heating of the filling during heating can be suppressed. As a result, a crunchy texture of vegetable ingredient can be felt, shrinkage and hardening of the filling during heating become less, roughness of the filling is felt less, and soft and smooth texture (moist feeling) can be felt. Furthermore, a drip from the filling does not transfer to the coating dough easily, even when the time lapses after heating cooking, the amount of juice immediately after baking (juiciness) can be maintained. This also suppresses transfer of water into the coating dough, which in turn maintains chewiness of the coating dough and preferable texture of the coating dough.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows illustrative drawings of the comparison of frozen heated gyoza dumpling of the present invention and conventional frozen gyoza dumpling.

FIG. 2 shows illustrative drawings of the comparison of the states of the frozen heated gyoza dumpling of the present invention and conventional frozen gyoza dumpling during heating cooking.

FIG. 3 shows one embodiment of the production steps of the frozen heated gyoza dumpling of the present invention.

FIG. 4 is a plan view of the principal part of a first example of the shape of a packaging tray.

FIG. 5 is a cross-sectional view of FIG. 4 along V-V.

FIG. 6 is a plan view of the principal part of a second example of the shape of a packaging tray.

FIG. 7 is a cross-sectional view of FIG. 6 along VII-VII.

FIG. 8 is a plan view of the principal part of a third example of the shape of a packaging tray.

FIG. 9 is a cross-sectional view of FIG. 8 along IX-IX.

FIG. 10 is a plan view of the principal part of a fourth example of the shape of a packaging tray.

FIG. 11 is a cross-sectional view of FIG. 10 along XI-XI.

### DESCRIPTION OF EMBODIMENTS

The embodiments will now be described with reference to the accompanying drawings, wherein like reference numerals designate corresponding or identical elements throughout the various drawings.

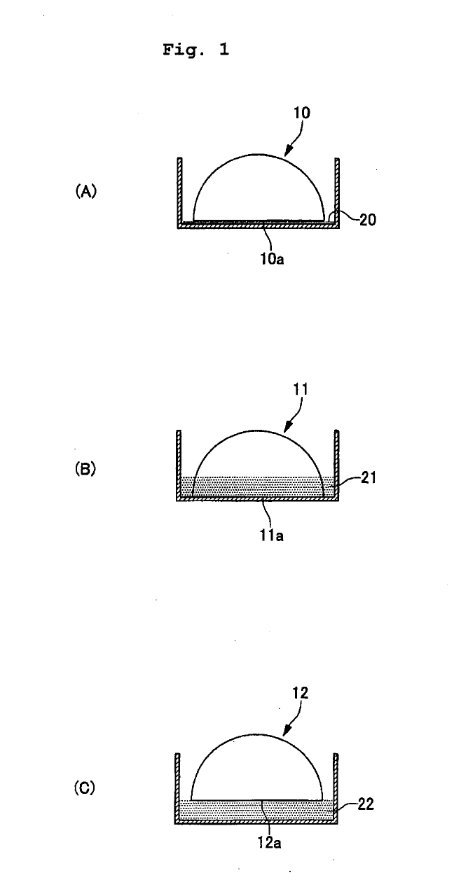

In FIG. 1, a conventional, general frozen heated gyoza dumpling (hereinafter sometimes to be referred to as frozen gyoza dumpling) 10 before heating cooking is, as shown in FIG. 1(A), in a state where fat and/or oil 20 and the like are attached thin onto the surface 10a to be baked. In contrast, a frozen gyoza dumpling 11 of the present invention is in a state shown in FIG. 1(B) wherein a batter liquid 21 is integrally attached in a frozen state to a surface 11a to be baked side of a frozen gyoza dumpling 11 in a frozen state or in a state shown in FIG. 1(C) wherein a batter liquid 22 is integrally attached in a frozen state only to a surface 12a to be baked of a frozen gyoza dumpling 12 in a frozen state. When a batter liquid is attached only to a surface to be baked, the batter liquid and a gyoza dumpling are brought into contact with each other, rather than immersing a gyoza dumpling in the batter liquid. The surface to be baked is, as known well, a surface placed on the side of a baking apparatus via a batter liquid when a frozen gyoza dumpling is heat-cooked using a baking apparatus such as a frying pan and the like, on which a baked color is produced by heating cooking.

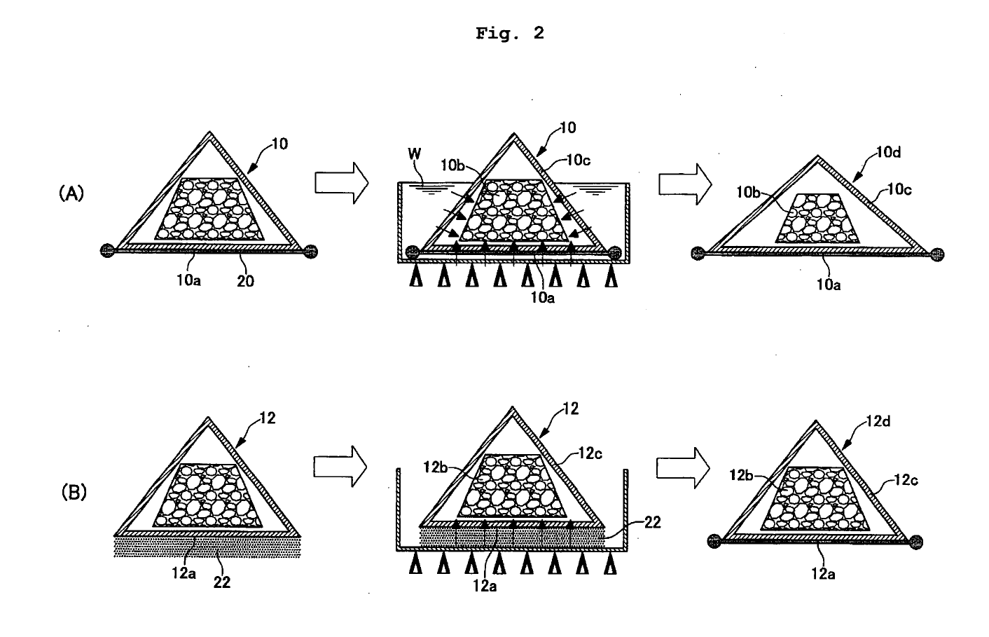

When a conventional frozen gyoza dumpling 10 shown in FIG. 1(A), in which fat and/or oil 20 and the like are thinly attached to the surface 10a to be baked, is heat-cooked in a frying pan containing oil spread therein as necessary, a large amount of water is added and a lid is placed to produce a steam-baked state. Then, as shown in FIG. 2(A), the frozen gyoza dumpling 10 is heated from the surface 10a to be baked while also being heated by the surrounding heated water (boiling water W). As a result, the filling 10b is overheated to allow easy flowing out of the juice and the surrounding coating dough 10c is softened on absorption of water. Therefore, the gyoza dumpling 10d after baking sometimes becomes flat as a whole since the surrounding coating dough 10c loses chewiness, and the filling 10b may shrink and becomes hard as compared to that before heating.

On the other hand, in the case of the frozen gyoza dumpling 12 of the present invention wherein the batter liquid 22 in a frozen state is integrally attached to the surface 12a to be baked shown in FIG. 1(C), since a given amount of the batter liquid 22 is attached to the surface 12a to be baked, addition of water is not necessary during heating cooking and placing a lid is sufficient. As shown in FIG. 2(B), therefore, it is mainly heated from the surface 12a to be baked via the heated and dissolved batter liquid 22. Consequently, the surrounding coating dough 12c, unlike conventional manner, is not heated by the surrounding boiling water, but only steamed with vapor, with only the surface 12a to be baked being baked. As a result, the surrounding coating dough 12c does not lose chewiness, and the finish of baking keeps the shape before heating cooking. Furthermore, since the filling 12b is also mainly heated from the surface 12a to be baked, it is free from overheating to allow flowing out of a large amount of juice and appropriately heated while keeping the shape before heating cooking. Therefore, the gyoza dumpling 12d after baking has a crispy texture of the baked surface 12a, hetero texture and juicy texture of the filling 12b, and the surrounding coating dough 12c also becomes superior in the texture with chewiness.

The frozen heated gyoza dumpling in the present invention refers to a gyoza dumpling obtained by wrapping the filling with coating dough, heating cooking same by steaming and the like, and freezing same. The shape and the cooking method of the gyoza dumpling itself are not particularly limited. Also, the manufacturing method of the gyoza dumpling itself is not particularly limited and, as the manufacturing methods of filling and coating dough, the methods well known to those of ordinary skill in the art can be used.

The batter liquid in the present invention is a mixture of 70-90% (wt %, hereinafter the same) of water with fat and/or oil and the like, and the batter liquid is attached to a frozen gyoza dumpling at a proportion of 18-30 parts by weight per 100 parts by weight of a gyoza dumpling. As a result, the batter liquid in a frozen state is dissolved and partly evaporated during heating cooking of the frozen gyoza dumpling, whereby the frozen gyoza dumpling can be placed in a suitable steam-baked state.

When the amount of water in the batter liquid relative to a gyoza dumpling is too small, a sufficient steam-baked state cannot be ensured during heating cooking, and the texture of surrounding coating dough may be impaired, and the finish of baking may become uneven. In contrast, when the amount is too high, the filling is sometimes overheated, and the surrounding coating dough may have a weak chewiness. Therefore, the amount of the batter liquid relative to a gyoza dumpling is determined according to the blending ratio of the batter liquid, particularly the amount of water, which is 18-30 parts by weight, preferably 24-30 parts by weight, per 100 parts by weight of a gyoza dumpling as mentioned above.

The water content of the batter liquid is 70-90 wt %, preferably 70-85 wt %. When the water content of the batter liquid is less than 70 wt %, burn is easily developed during cooking and a bonded part of coating dough of a gyoza dumpling tends to be hardened. When the water content of the batter liquid is more than 90 wt %, the crunchy feeling of vegetables tends to be weak.

Examples of the main component of the batter liquid other than water include fat and/or oil, starch and grain flour, and emulsifier and emulsifying adjuvant may be further included.

Since the batter liquid contains fat and/or oil, unevenness in baking does not occur easily even without using oil during cooking. When the batter liquid does not contain fat and/or oil, the bottom surface of a gyoza dumpling is easily burnt during cooking, or detachment of the gyoza dumpling from the frying pan tends to be difficult. The content of the fat and/or oil in the batter liquid is preferably 5-29.5 wt %, more preferably 12-23 wt %. The content of the starch or grain flour in the batter liquid is generally not more than 5 wt %, preferably 0.5-5 wt %, particularly preferably 2-4.5 wt %.

While the batter liquid is not particularly limited as long as water is contained in a proportion of 70-90 wt %. When the blending weight ratio of starch or grain flour, fat and/or oil and water is set to fall within the range of 0.5-5:5-29.5:70-90, heating cooking affords a preferable baked color. The batter liquid may further contain soy sauce, salts, amino acids, gums, celluloses and the like.

While the aforementioned fat and/or oil are not particularly limited, rapeseed oil, canola oil, soybean oil, corn oil, safflower oil, palm oil, lard, shortening, butter, sesame oil, olive oil and the like can be used alone or in combination. Particularly, rapeseed oil, canola oil and soybean oil are preferable.

In the present invention, the batter liquid can contain starch or grain flour. It is preferable to use grain flour, since grain flour has a lower rate of damaged starch than starch, and therefore, starch particle does not swell with ease and a crispy texture of the baked surface is easily maintained even when the time passes after baking. As used herein, the damaged starch rate refers to the ratio of starch particles damaged by the loading of flour milling or crushing.

While the aforementioned starch is not particularly limited, non-glutinous rice starch, glutinous rice starch, wheat starch, cornstarch, waxy cornstarch, tapioca starch, sago palm starch, mung bean starch, potato starch, sweet potato starch and the like can be used, and particularly, non-glutinous rice starch and glutinous rice starch are preferable. While the aforementioned grain flour is not particularly limited, wheat flour, rice flour, corn flour, barley flour, buckwheat flour, potato flour, soybean flour, adzuki bean flour, barnyard millet flour, chestnut flour, millet flour and the like can be used, and particularly, rice flour is preferable since it has a low protein content and can easily confer a crispy texture after baking.

As the aforementioned emulsifier, lecithin (derived from soybean, derived from egg etc.), enzymatically decomposed lecithin, sugar ester, monoglyceride, polyglycerol ester of fatty acid, propylene glycol ester of fatty acid and the like can be used, and particularly, lecithin is preferable, and lecithin derived from soybean is more preferable. As the aforementioned emulsifying adjuvant, a protein can be used, and generally, egg white powder, isolated soy protein, powdered skim milk, wheat protein powder, whole egg powder and the like can be used. Particularly, egg white powder and powdered skim milk are preferable.

While the content of the emulsifier in a batter liquid is not particularly limited, it is generally 0.1-1.0 wt %, preferably 0.15-0.25 wt %. The content of the emulsifying adjuvant in the batter liquid is generally 0-1.5 wt %, preferably 0.1-0.5 wt %. Using an emulsifier, the batter liquid comes to have an emulsified state, which affords uniform property of the batter liquid, and suppresses unevenness in baking of a frozen heated gyoza dumpling, whereby uniform, preferable texture and appearance can be conferred to a heated gyoza dumpling.

The manufacturing method of the frozen heated gyoza dumpling of the present invention includes heat treating a raw gyoza dumpling with a surface 12a to be baked formed on one surface of coating dough wrapping the filling, and freezing same while being in contact with or immersed in 18-30 parts by weight of a batter liquid containing 70-90 wt % of water per 100 parts by weight of the gyoza dumpling, such that the batter liquid is attached only on the surface to be baked, or the surface to be baked and a side surface continuing from the surface to be baked and frozen in a height of not more than 8 mm from the surface to be baked.

In the present invention, when a batter liquid is attached to the surface to be baked 11a and a side surface surrounding the surface to be baked of the frozen gyoza dumpling 11, as shown in FIG. 1(B), the gyoza dumpling is immersed in the batter liquid such that the height from the surface to be baked would be within the range of not more than 8 mm, preferably not more than 5 mm. When the batter liquid attaches to an upper part of the side surface during heating cooking, the heating amount from the periphery becomes high and, for example, coating dough may have a weak chewiness, or the filling may be overheated to degrade the texture.

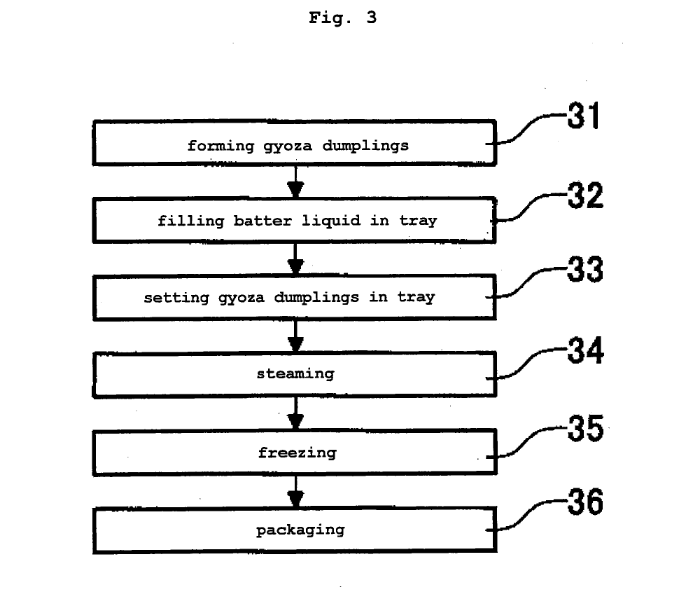

While the method of integrating a batter liquid on the surface to be baked of a gyoza dumpling in a frozen state may be any, a tray used for packaging a frozen gyoza dumpling is utilized, and the steps shown in FIG. 3 are sequentially performed, whereby a frozen gyoza dumpling with a batter liquid integrally attached to the surface to be baked side can be produced. That is, in step 31, the filling is wrapped with coating dough by a general step to give a gyoza dumpling (raw gyoza dumpling), a given amount of a batter liquid is filled in a tray previously molded in step 32, a gyoza dumpling with the surface to be baked facing downward is placed in the tray filled with the batter liquid in step 33, and a steaming step is performed in step 34 to heat the gyoza dumpling, whereby the whole gyoza dumpling is heat denatured. In the next step 35, the batter liquid-attached heated gyoza dumpling obtained in step 34 is subjected together with the tray to a rapid freezing treatment to freeze the gyoza dumpling and the batter liquid in an integrally-attached state, and finally, tightly seal-packaging same in a pouch and the like in step 36, whereby the frozen gyoza dumpling integrally having the frozen batter liquid can be produced.

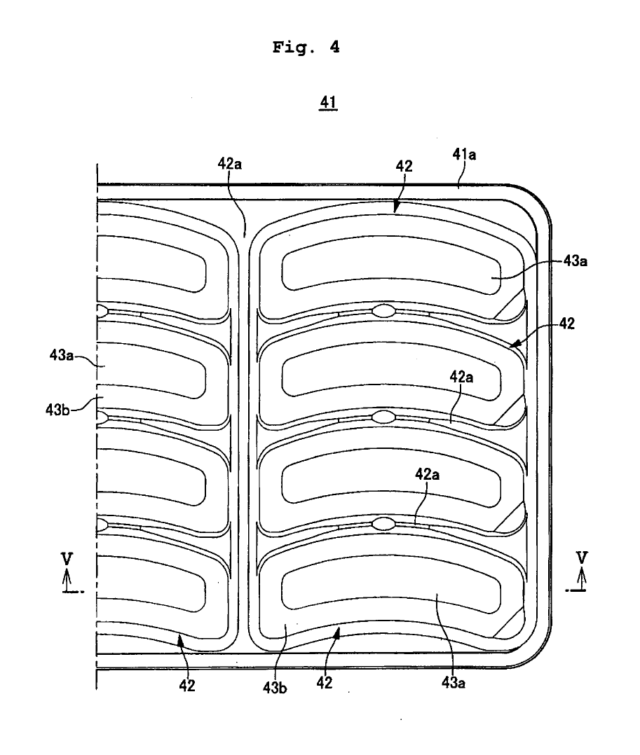

While the shape of the tray to be used can be freely selected according to the number of gyoza dumplings, the size, shape and the like of the gyoza dumpling, frozen gyoza dumplings wherein a given amount of a batter liquid is integrally attached to the surface to be baked can be produced easily by using the trays molded in respective shapes as shown in, for example, FIG. 4 to FIG. 11. Naturally, the trays shown in FIG. 4 to FIG. 11 are not limitative.

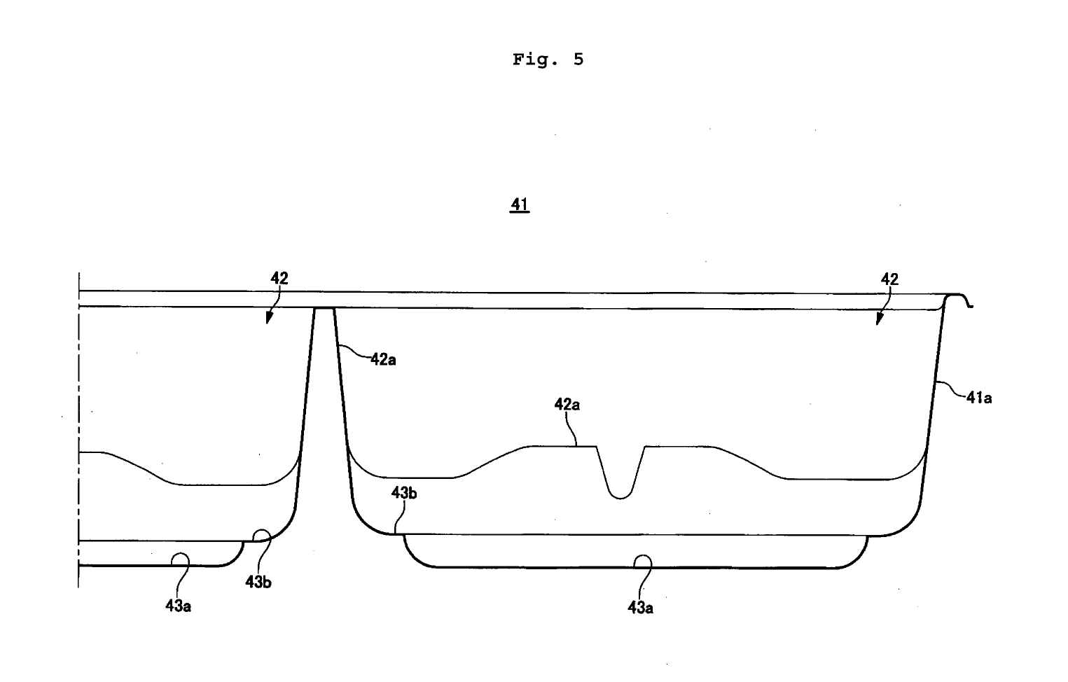

In the tray 41 shown in FIG. 4 and FIG. 5, a plurality of partitioning protrusion parts 42a are formed inside a rectangular shape tray 41 having an upstanding strip portion 41a on the periphery, and the partitioning protrusion parts 42a form a plurality of gyoza dumpling holding parts 42 to hold each one of the gyoza dumplings. On the bottom surface of each gyoza dumpling holding part 42 is formed a recess part 43a for storing batter liquid, which has an opening dimension slightly smaller than the surface to be baked of the gyoza dumpling, and in an opening periphery of the recess part 43a is formed a supporting surface 43b to support the surface to be baked of the gyoza dumpling. A gyoza dumpling held by the gyoza dumpling holding part 42 is supported by the aforementioned supporting surface 43b at the periphery part of the surface to be baked, and the central part of the surface to be baked is in contact with a batter liquid filled in advance in the aforementioned recess part 43a.

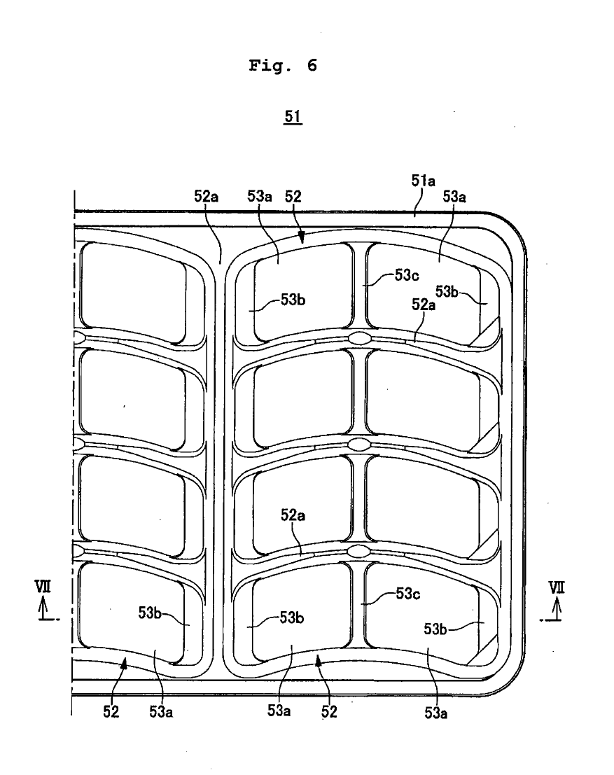

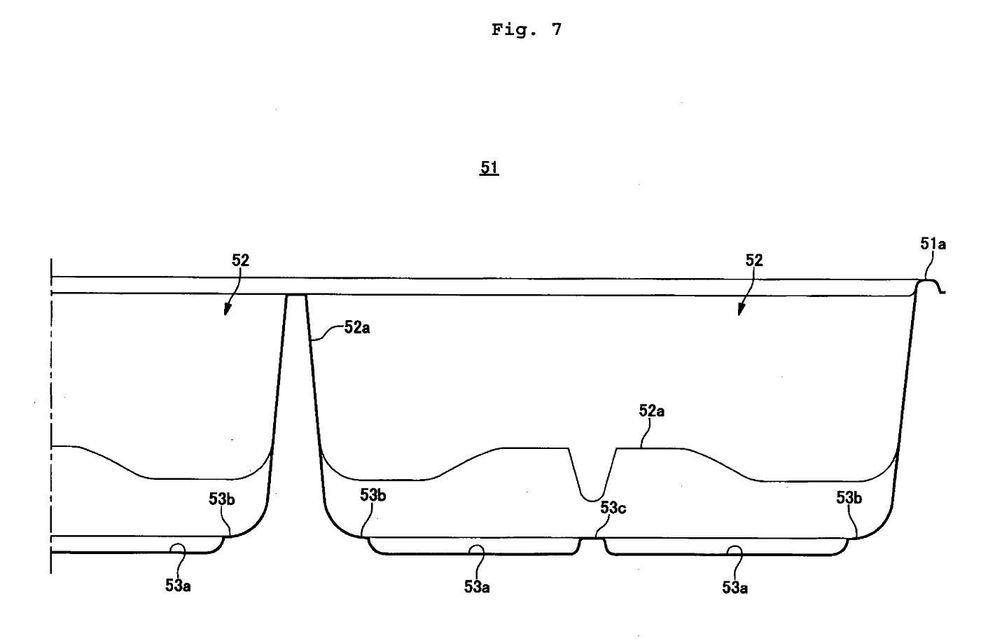

In the tray 51 shown in FIG. 6 and FIG. 7, a plurality of partitioning protrusion parts 52a are formed inside a rectangular shape tray 51 having an upstanding strip portion 51a on the periphery, and the partitioning protrusion parts 52a form a plurality of gyoza dumpling holding parts 52 to hold each one of the gyoza dumplings. On the bottom surface of each gyoza dumpling holding part 52 is formed a recess part 53a for storing batter liquid, which has an opening dimension in the upper-lower direction in FIG. 6 which is greater than the upper-lower size of the surface to be baked of a gyoza dumpling, and an opening dimension in the left-right direction, which is smaller than the size in the left-right direction of the surface to be baked of a gyoza dumpling, and a supporting surface 53b is formed on both left and right sides of the recess part 53a. In the center of the recess part 53a is formed a supporting projection part 53c oriented in the upper-lower direction. A gyoza dumpling held by the gyoza dumpling holding part 52 is supported by the supporting surface 53b respectively at both ends of the surface to be baked, and the central part of the surface to be baked is supported by the supporting projection part 53c, and the surface to be baked other than the supported part is in contact with a batter liquid filled in advance in the aforementioned recess part 53a.

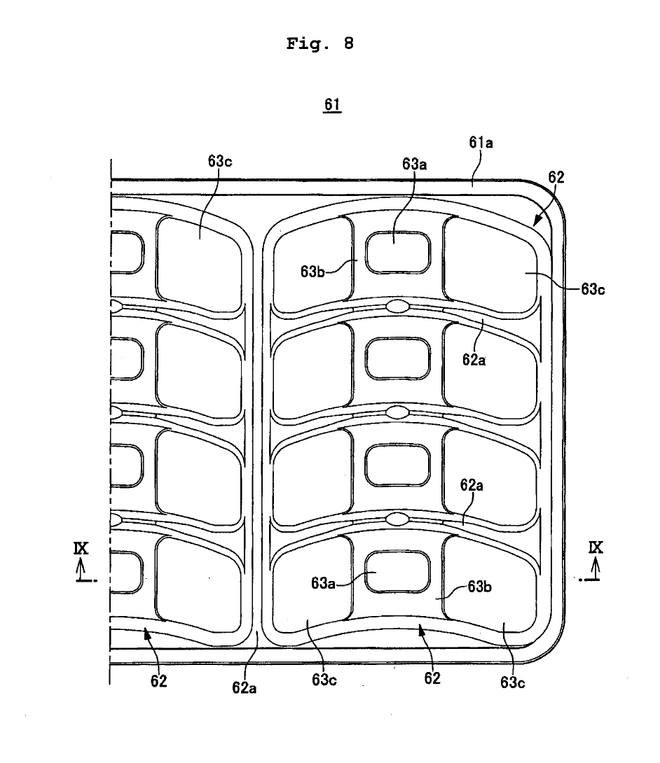

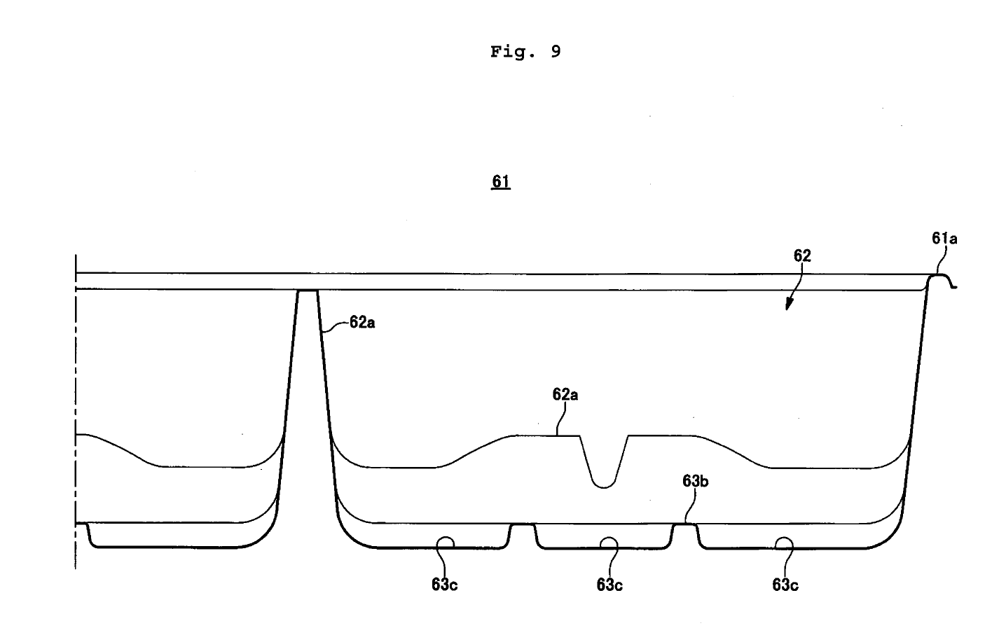

In the tray 61 shown in FIG. 8 and FIG. 9, a plurality of partitioning protrusion parts 62a are formed inside a rectangular shape tray 61 having an upstanding strip portion 61a on the periphery, and the partitioning protrusion parts 62a form a plurality of gyoza dumpling holding parts 62 to hold each one of the gyoza dumplings.

On the center part of the bottom surface of each gyoza dumpling holding part 62 is formed a first recess part 63a having an opening dimension smaller than the center part of the surface to be baked, and on both sides of the central recess part 63a are each formed, via a supporting projection part 63b formed to surround the first recess part 63a, a second recess part 63c having an opening dimension larger than the both left and right end parts of the surface to be baked. A gyoza dumpling held by the gyoza dumpling holding part 62 is supported by the aforementioned supporting surface 63b at the surface to be baked corresponding to the periphery part of the aforementioned first recess part 63a, the central part of the surface to be baked is in contact with a batter liquid filled in advance in the aforementioned first recess part 63a, and the both ends of the surface to be baked are in contact with a batter liquid filled in advance in the aforementioned second recess part 63c.

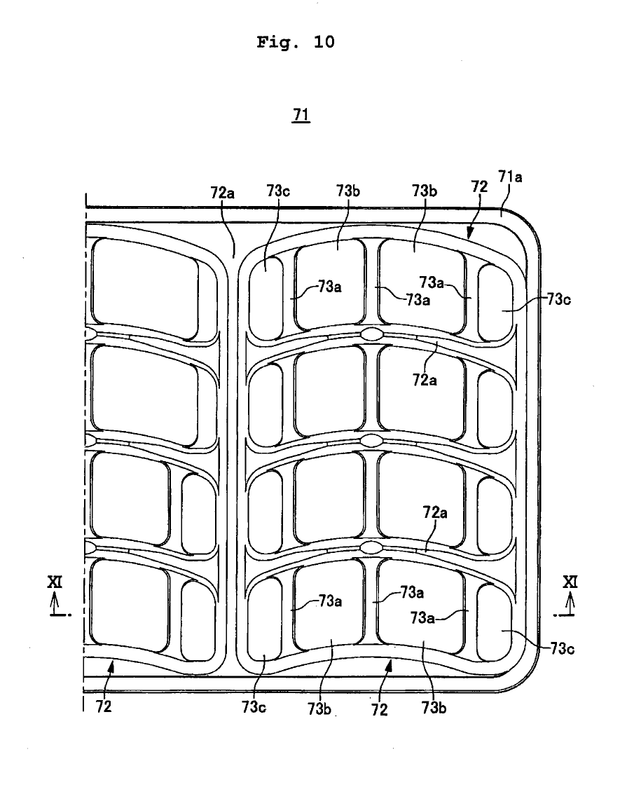

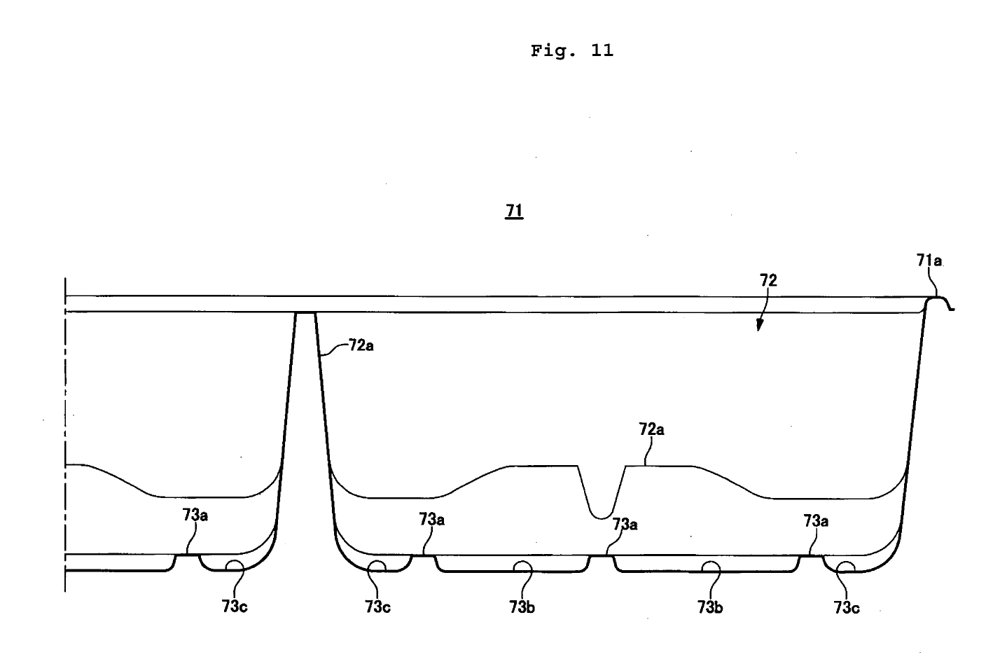

In the tray 71 shown in FIG. 10 and FIG. 11, a plurality of partitioning protrusion parts 72a are formed inside a rectangular shape tray 71 having an upstanding strip portion 71a on the periphery, and the partitioning protrusion parts 72a form a plurality of gyoza dumpling holding parts 72 to hold each one of the gyoza dumplings. On the bottom surface of each gyoza dumpling holding part 72 are formed two comparatively large first recess parts 73b on the central side of the surface to be baked, and two comparatively small second recess parts 73c on the both sides of the surface to be baked, which are partitioned by three rows of supporting projection parts 73a oriented in the upper-lower direction in FIG. 10. A gyoza dumpling held by the gyoza dumpling holding parts 72 is supported by the supporting surface 73a at 3 points of the surface to be baked, and the surfaces to be baked other than the supported parts are each in contact with a batter liquid filled in advance in the aforementioned first recess part 73b and the aforementioned second recess part 73c.

In respective trays shown in FIG. 4 to FIG. 11, by setting the amount of the batter liquid to be filled in the recess part to reach the opening edge of each recess part, the batter liquid contacts only the surface to be baked. By filling each recess part with a given amount of the batter liquid, and performing a freezing treatment of gyoza dumplings set with the surface to be baked facing the recess part in respective gyoza dumpling holding parts, the gyoza dumplings are frozen with the batter liquid in each recess part in contact with a part of the surface to be baked of the gyoza dumplings and attached to the surface to be baked, whereby frozen gyoza dumplings with the batter liquid integrally attached to the surface to be baked can be obtained. In addition, by filling the batter liquid such that a slight amount thereof flows over from the opening edge of each recess part, the frozen batter liquid attaches to the surface 11a to be baked and a side surface surrounding the surface to be baked. The amount of the batter liquid relative to a gyoza dumpling can be adjusted by appropriately setting the depth of each recess part.

### EXAMPLES

The present invention is explained in the following by referring to Examples. It is needless to say that the present invention is not limited to the Examples.

### Example 1

As for gyoza dumplings, a filling (13.2 g) from a total mixture (32 g) of meat (mixture of ground pork and ground chicken, 260 g), vegetables (mixture of cabbage, onion, Chinese chive, garlic, 550 g), egg white (25 g), sesame oil (20 g), sake (10 g), spice and seasoning, which has a water content of about 68%, was wrapped with commercially available gyoza dumpling coating dough (5.6 g) to give a raw gyoza dumpling having a total weight of about 19 g, which was steam-heated separately from a batter liquid and rapidly frozen to give a frozen heated gyoza dumpling. As for a batter liquid, an emulsified batter liquid adjusted to contain water 84%, canola oil 13%, rice flour 2.5%, emulsifier (lecithin derived from soybean, 0.1%), and emulsifying adjuvant 0.4% (egg white powder) was prepared and filled in a flat bottom tray at each weight of 3, 4, 5, 6, 7 g, which was steam-heated separately from the gyoza dumpling, and rapidly frozen to give a plate-like frozen heated emulsified batter liquid.

The frozen heated emulsified batter liquid was adhered to the surface to be baked of a frozen heated gyoza dumpling to give a frozen gyoza dumpling for testing. Each frozen gyoza dumpling for testing was heat-cooked using a household gas stove and a frying pan having a diameter of 26 cm, in which 12 frozen gyoza dumplings for testing were placed side by side per one testing and a medium heat was used. The steam-baking time with the lid put thereon was adjusted as follows according to the amount of the batter liquid. After the completion of is steam-baking time, the lid was removed and the baked color was produced on the baked surface.

batter liquid 3 g: steam-baking 5.5-6.0 min.→baked color development 2.0-2.5 min.

batter liquid 4 g: steam-baking 6.0-6.5 min.→baked color development 2.0-2.5 min.

batter liquid 5 g: steam-baking 7.0-7.5 min.→baked color development 2.0-2.5 min.

batter liquid 6 g: steam-baking 7.5-8.0 min.→baked color development 2.0-2.5 min.

batter liquid 7 g: steam-baking 8.0-8.5 min.→baked color development 2.0-2.5 min.

A sensory evaluation of the gyoza dumpling after baking was performed by six panelists sufficiently trained as regards the properties of the gyoza dumpling. The evaluation items included “amount of juice in filling”, “moist feeling of filling”, “crunchy feeling of vegetables”, “texture (chewiness) of coating dough”, and “unevenness of baked color between gyoza dumplings”. The evaluation criteria are shown in Table 1, and the evaluation results are shown in Table 2. From the results shown in Table 2, the amount of batter liquid relative to 100 parts by weight of gyoza dumpling is preferably 18-30 parts by weight.

TABLE 1
amount of juice in filling

| | |
|---|---|
| ⊙ | very high |
| ○ | high |
| Δ | rather low |
| x | very low |

crunchy feeling of vegetables

| | |
|---|---|
| ⊙ | highly crunchy |
| ○ | crunchy |
| Δ | not very crunchy |
| x | hardly crunchy |

unevenness of baked color between gyoza dumplings

| | |
|---|---|
| ⊙ | very low |
| ○ | low |
| Δ | rather high |
| x | very high |

moist feeling of filling

| | |
|---|---|
| ⊙ | highly moist and smooth |
| ○ | moist and smooth |
| Δ | dryness is feltsomewhat |
| x | dryness is felt |

texture (chewiness) of coating dough

| | |
|---|---|
| ⊙ | highly chewy |
| ○ | chewy |
| Δ | less chewy |
| x | hardly chewy |

* chewiness ... texture of coating dough showing suitable elasticity, not too hard and not too soft

TABLE 2

| | | | | | | amount of |
|---|---|---|---|---|---|---|
| | | | | | | batter liquid |
| | | | | | | attached to |
| amount of batter | | | | texture | unevenness of | 100 parts by |
| liquid attached | amount of | | crunchy | (chewiness) | baking | weight of |
| to one gyoza | juice in | moist feeling | feeling of | of coating | between gyoza | gyoza |
| dumpling | filling | of filling | vegetables | dough | dumplings | dumpling |
| 7 g | Δ | Δ | X | ◯ | ⊙ | 36.8 |
| 6 g | Δ | Δ | Δ | ◯ | ⊙ | 31.6 |
| 5 g | ◯ | ◯ | ◯ | ⊙ | ◯ | 26.3 |
| 4 g | ◯ | ⊙ | ◯ | ◯ | ◯ | 21.1 |
| 3 g | ◯ | ◯ | ⊙ | Δ | Δ | 15.8 |

### Example 2

In the same manner as in Example 1, frozen heated gyoza dumplings were manufactured. As for a batter liquid, an emulsified batter liquid adjusted to contain rice flour 2.5%, emulsifier (lecithin derived from soybean, 0.1%), and emulsifying adjuvant 0.4% (egg white powder), and have a water content of 54%, 64%, 74%, 84%, 94%, and canola oil content of 43%, 33%, 23%, 13%, 3% was prepared and filled in a flat bottom tray at a water content of 3.6 g per one gyoza dumpling, which was steam-heated separately from the gyoza dumpling, and rapidly frozen to give a plate-like frozen heated emulsified batter liquid.

The frozen heated emulsified batter liquid was adhered to the surface to be baked of a frozen heated gyoza dumpling to give a frozen gyoza dumpling for testing. Each frozen gyoza dumpling for testing was heat-cooked using a household gas stove and a frying pan having a diameter of 26 cm, in which 12 frozen gyoza dumplings for testing were placed side by side per one testing and a medium heat was used. The steam-baking time with the lid put thereon was set to 6.0-6.5 min. After the completion of steam-baking time, the lid was removed and the baked color was produced on the baked surface by continuing heating for 2 min.

The gyoza dumplings after baking were evaluated for the items of “amount of juice in filling”, “moist feeling of filling”, “crunchy feeling of vegetables”, “texture of coating dough”, and “unevenness of baked color between gyoza dumplings” as in Example 1, added with “oil splashing”. The evaluation criteria of “oil splashing” are shown in Table 3, and the evaluation results are shown in Table 4. As is clear from the results, the frozen heated gyoza dumplings attached with a batter liquid having a water content of 74% (oil content 23%) or 84% (oil content 13%) were preferable.

TABLE 3
oil splashing

| | |
|---|---|
| ⊙ | scarce oil splashing on removing the lid |
| ○ | not much oil splashing on removing the lid |
| Δ | some oil splashing on removing the lid |
| x | oil splashing on removing the lid |

TABLE 4

| emulsified batter | | | | | | | unevenness | |
|---|---|---|---|---|---|---|---|---|
| liquid | | | amount | moist | | | of baking | |
| composition | | | of juice | feeling | crunchy | texture | between | |
| water | oil | amount of | in | of | feeling of | (chewiness) of | gyoza | oil |
| content | content | batter liquid | filling | filling | vegetables | coating dough | dumplings | splashing |
| 54% | 43% | 6.7 g/gyoza | X | X | X | X | ⊙ | X |
| | | dumpling | | | | | | |
| 64% | 33% | 5.6 g/gyoza | Δ | Δ | Δ | Δ | ⊙ | Δ |
| | | dumpling | | | | | | |
| 74% | 23% | 4.9 g/gyoza | ◯ | ◯ | ◯ | ◯ | ⊙ | ◯ |
| | | dumpling | | | | | | |
| 84% | 13% | 4.3 g/gyoza | ◯ | ⊙ | ◯ | ◯ | ◯ | ⊙ |
| | | dumpling | | | | | | |
| 94% | 3% | 3.8 g/gyoza | ⊙ | ⊙ | ⊙ | ⊙ | X | ⊙ |
| | | dumpling | | | | | | |

### Example 3

As a Comparative Example product, the frozen heated gyoza dumpling described in the aforementioned JP-A-2006-296428 was manufactured. That is, an emulsified batter liquid was filled in a tray at 1 g per one gyoza dumpling, 12 raw gyoza dumplings were placed side by side in the tray and steam-heated. Water (100 g) per 12 gyoza dumplings was added into the tray and they were rapidly frozen to give frozen heated gyoza dumplings to be the Comparative Example product. Raw gyoza dumplings were manufactured in the same manner as in Example 1. As a batter liquid, canola oil 25.0%, starch 8%, emulsifier (lecithin derived from soybean) 2%, and emulsifying adjuvant (egg white powder) 0.4% were added to water 64.6% and they were stirred to give an emulsified batter liquid for use.

Using a tray having the shape shown in the aforementioned FIG. 8 and FIG. 9, and a depth of a recess part of 4 mm, each recess part was filled with an emulsified batter liquid obtained by stirring water 83.7%, canola oil 12.7%, starch 2.5%, emulsifier (lecithin derived from soybean) 0.2%, and emulsifying adjuvant (egg white powder) 0.4%. The amount of the emulsified batter liquid per one gyoza dumpling was 4.3 g. Raw gyoza dumplings were set with the surface to be baked facing downward in the tray filled with the emulsified batter liquid, and steam-heated. They were rapidly frozen to give frozen heated gyoza dumplings having the emulsified batter liquid integrally attached to the surface to be baked (Example product). Comparative Example product and Example product were baked in the same manner as in Example 2, and the gyoza dumplings were evaluated immediately after baking, 10 min later, and 20 min later based on the same evaluation criteria as in Example 2. In addition, frozen heated gyoza dumplings were measured for the height of the batter liquid attached to the side surface from the surface to be baked. The results are shown in Table 5. As shown in Table 5, gyoza dumplings having a height of the batter liquid attached to the side surface from the surface to be baked of 0-6 mm were preferable.

TABLE 5

| | height of | | | | | | | |
|---|---|---|---|---|---|---|---|---|
| | batter | | | | | | | |
| | liquid | | | | | | | |
| | attached to | | | | | | | |
| | side | | amount | | | | unevenness | |
| | surface | | of | moist | | texture | of baking | |
| | from | | juice | feeling | crunchy | (chewiness) | between | |
| experimental | surface to | | in | of | feeling of | of coating | gyoza | oil |
| plot | be baked | preservation | filling | filling | vegetables | dough | dumplings | splashing |
| Comparative | 18-20 mm | immediately | ⊙ | Δ | Δ | X | Δ | X |
| Example | | after | | | | | | |
| | | baking | | | | | | |
| | | after 10 min | ◯ | X | X | X | — | — |
| | | after 20 min | Δ | X | X | X | — | — |
| Example | 0-6 mm | immediately | ◯ | ⊙ | ◯ | ◯ | ◯ | ⊙ |
| | | after | | | | | | |
| | | baking | | | | | | |
| | | after 10 min | ⊙ | ⊙ | ◯ | ◯ | — | — |
| | | after 20 min | ⊙ | ◯ | Δ | ◯ | — | — |

### EXPLANATION OF SYMBOLS

10, 11, 12 . . . frozen heated gyoza dumpling, 10a, 11a, 12a . . . surface to be baked, 10b, 12b . . . filling, 10c, 12c . . . surrounding coating dough, 10d, 12d gyoza dumpling after baking, 20 . . . fat and/or oil, 21, 22 . . . batter liquid, 41, 51, 61, 71 . . . tray, 41a, 51a, 61a, 71a . . . upstanding strip portion, 42, 52, 62, 72 . . . gyoza dumpling holding part, 42a, 52a, 62a, 72a . . . partitioning protrusion part, 43a, 53a . . . recess part, 43b, 53b . . . supporting face, 53c, 63b, 73a . . . supporting projection part, 63a, 73b . . . first recess part, 63c, 73c . . . second recess part

### INDUSTRIAL APPLICABILITY

According to the present invention, a frozen heated gyoza dumpling easy to cook by heating after freeze preservation and superior in the texture can be obtained. Therefore, it is extremely useful in the field of foods.

1. A frozen heated gyoza dumpling, comprising:
a gyoza dumpling having a surface to be baked; and
a frozen batter liquid attached to at least the surface, the frozen batter liquid being made from a batter liquid including 70-90 wt % of water,
wherein the batter liquid is applied in an amount of 18-30 parts by weight per 100 parts by weight of the gyoza dumpling.

2. The frozen heated gyoza dumpling according to claim 1, wherein the batter liquid comprises fat and/or oil.

3. The frozen heated gyoza dumpling according to claim 2, wherein the batter liquid comprises the fat and/or oil in an amount of 5-29.5 wt %.

4. The frozen heated gyoza dumpling according to claim 1, wherein the batter liquid comprises starch or grain flour, fat and/or oil and water, and a blending weight ratio of the starch or grain flour, fat and/or oil and water is 0.5-5:5-29.5:70-90.

5. The frozen heated gyoza dumpling according to claim 1, wherein the batter liquid comprises grain flour, fat and/or oil and water, and a blending weight ratio of the grain flour, fat and/or oil and water is 0.5-5:5-29.5:70-90.

6. The frozen heated gyoza dumpling according to claim 5, wherein the grain flour is rice flour.

7. The frozen heated gyoza dumpling according to claim 1, wherein the frozen batter liquid is attached only to the surface to be baked.

8. The frozen heated gyoza dumpling according to claim 1, wherein the frozen batter liquid is attached to the surface to be baked and a side surface continuing from the surface to be baked, and the frozen batter liquid attached to the side surface is in a height of not more than 8 mm from the surface to be baked.

9. The frozen heated gyoza dumpling according to claim 8, wherein the frozen batter liquid attached to the side surface is in a height of not more than 5 mm from the surface to be baked.

10. A method of manufacturing a frozen heated gyoza dumpling, is comprising:
heat treating a raw gyoza dumpling with a surface to be baked formed on one surface of a coating dough which wraps filling; and
freezing a heat-treated gyoza dumpling while being in contact with or immersed in 18-30 parts by weight of a batter liquid containing 70-90 wt % of water per 100 parts by weight of the gyoza dumpling, such that the batter liquid is applied only to the surface to be baked, or applied to the surface to be baked and a side surface continuing from the surface to be baked, and that a frozen batter liquid is formed in a height of not more than 8 mm from the surface to be baked.

11. The method according to claim 10, wherein the frozen batter liquid attached to the side surface is in a height of not more than 5 mm from the surface to be baked.

12. The method according to claim 10, wherein the frozen batter liquid is attached only to the surface to be baked.

13. The method according to claim 10, wherein the batter liquid comprises fat and/or oil.

14. The method according to claim 13, wherein of the batter liquid comprises the fat and/or oil in an amount of 5-29.5 wt %.

15. The method according to claim 10, wherein the batter liquid comprises starch or grain flour, fat and/or oil and water, and a blending weight ratio of the starch or grain flour, fat and/or oil and water is 0.5-5:5-29.5:70-90.

16. The method according to claim 10, wherein the batter liquid comprises grain flour, fat and/or oil and water, and a blending weight ratio of the grain flour, fat and/or oil and water is 0.5-5:5-29.5:70-90.

17. The method according to claim 12, wherein the batter liquid comprises starch or grain flour, fat and/or oil and water, and a blending weight ratio of the starch or grain flour, fat and/or oil and water is 0.5-5:5-29.5:70-90.

18. The method according to claim 12, wherein the batter liquid comprises grain flour, fat and/or oil and water, and a blending weight ratio of the grain flour, fat and/or oil and water is 0.5-5:5-29.5:70-90.

19. The method according to claim 14, wherein the batter liquid comprises starch or grain flour, fat and/or oil and water, and a blending weight ratio of the starch or grain flour, fat and/or oil and water is 0.5-5:5-29.5:70-90.

20. The method according to claim 14, wherein the batter liquid comprises grain flour, fat and/or oil and water, and a blending weight ratio of the grain flour, fat and/or oil and water is 0.5-5:5-29.5:70-90.
